(19) United States
(12) Patent Application Publication
(10) Pub. No.: US 2025/0138913 A1
(43) Pub. Date: May 1, 2025

(54) SYSTEMS AND METHODS FOR COORDINATING PROCESSING OF NOTIFICATIONS FROM DIFFERENT SOURCES AND IMPLEMENTING OF WORKFLOWS

(71) Applicant: Zuora, Inc., Redwood City, CA (US)

(72) Inventors: Alvin Beyerlein, Asheville, NC (US); Shakir Karim, Oakland, CA (US); Kevin Suer, Alameda, CA (US)

(21) Appl. No.: 18/386,106

(22) Filed: Nov. 1, 2023

(51) Int. Cl. G06F 9/54; G06F 16/23; G06F 16/25; G06F 16/27

(52) U.S. Cl. CPC G06F 9/542; G06F 16/2379; G06F 16/258; G06F 16/27

(57) ABSTRACT

The multi-tenant system includes one or more hardware processors that store product information in one or more databases, the product information defining subscription products available to subscribers of a tenant and sources where subscriptions to the subscription products are available. The hardware processors store subscription information which includes subscriber identifiers, a tenant identifier, and subscription statuses of the subscription products. The hardware processors ingest, from the sources, event notifications of subscription updates to the subscription information. The event notifications indicate update types of the subscription updates. The hardware processors filter the event notifications based on the update types. The hardware processors validate respective sources of the event notifications. The hardware processors reformat the event notifications to a standardized format. The hardware processors generate messages corresponding to each of the reformatted, filtered and validated event notifications, store the messages within a data structure, and map the messages to respective workflows.

### TECHNICAL FIELD

This disclosure pertains to coordinating and synchronizing the processing of notifications received from different distribution channels and implementing actions as a result of the processing.

### BACKGROUND

Within a multi-tenant computing system, a tenant may have distributed resources across different distribution channels. The tenant may receive updates or notifications regarding statuses of the resources from each of the individual distribution channels using interfaces such as application programming interfaces (APIs). These updates may relate to subscription-based updates corresponding to any of the resources. Challenges in processing the updates and implementing further actions may be attributed to isolation among the distribution channels and different protocols of at least some of the distribution channels, in addition to the updates being received in batch rather than at the moment they actually occur. Therefore, current solutions may be limited to receiving and processing the updates in an isolated and delayed manner for each distribution channel, if they are able to be processed at all. Synchronizing or merging the processing of the updates across the distribution channels remains somewhat of a bottleneck, thereby limiting the ability to effectively coordinate processing of events across the different distribution channels.

### SUMMARY

A claimed solution rooted in computer technology overcomes problems specifically arising in the realm of computer technology. The claimed solution implements an integrated notification processing mechanism at a processing server that obtains notifications from different sources, servers, channels, streams, or platforms (hereinafter “sources”), deciphers the notifications, maps the notifications to specific actions, pipelines, or workflows (hereinafter “workflows”), and implements the workflows. Such a solution obviates the need to build custom interfaces with individual sources, to constantly or manually monitor for notifications, or to manually implement certain actions as a result of the notifications. Efficient server-to-server communication to obtain notifications and information about workflows promotes immediacy and flexibility of scaling the solution, especially when an expected rate or volume of notifications is high and/or variable.

Embodiments of the invention enable receiving or ingesting (hereinafter “ingesting”), at a gateway or proxy (hereinafter “gateway”) of a computing system, one or more notifications, indications, or calls (hereinafter “event notifications”) of an event from a source. An event may encompass a change in a consumption, schedule, utilization, or subscription (hereinafter “subscription”) status of a resource (e.g., a product or a service) that is provisioned or distributed (hereinafter “distributed”) via the source. The source may include a digital application store (e.g., Google Play®, Apple App Store®, Amazon Prime®, Roku®), and/or server that hosts or makes available subscription products and/or services that are provided by a provisioning entity, or tenant, which coordinates provisioning of the resources to subscribers. In some examples, the source may include any other platform that distributes resources. The source may also monitor or track statuses regarding the resources, such as subscription-based statuses of consuming entities (e.g., individual users or subscribers) who may consume any of the resource, as subscribers of a tenant. Any updates obtained from the source may be transmitted, to the gateway, as event notifications of subscription updates. For example, an event notification may be triggered by a consuming entity requesting a subscription-based change, such as, via an IoT or media device of the consuming entity. This requested subscription-based change is reflected at the source and transmitted, via an event notification, to the gateway. Therefore, any event notifications transmitted to the gateway mirror those reflected or obtained at the source. The event notifications may be manifested as packets, each including a header and a payload. In some examples, the ingestion of the event notifications may be rate-limited. This rate-limiting may entail restricting a number of event notifications from a particular provisioning entity within a given time period to prevent or mitigate overload and potential fraud.

Upon ingestion, the gateway, and/or a different component of the computing system, may perform filtering, and validating or authenticating (hereinafter “validating”) sources of each of the event notifications, and reformatting the event notifications. The filtering may be based on a criteria, such as whether the event notifications would trigger a downstream action such as a workflow action. Certain event notification types, or update types, may be unmapped to any workflow actions. For example, an event notification such as a continuation of a previous subscription may be filtered out because no change would be implemented as a result of such event notification, and/or no workflows are mapped to such an event notification type. Filtering out such event notifications before they are processed may alleviate processing loads.

Meanwhile, the validating may include, for example, validating a token or string (hereinafter “token”) within each of the event notifications. In other examples, additionally or alternatively, the validating may include other protocols such as validating a private key, or decrypting identification information such as an identifier (e.g., username) and password. Next, the reformatting of the event notifications may entail decrypting and/or standardizing the event notifications into messages of a standardized format that is compatible with processing characteristics of the computing system. The reformatting may further include obtaining tenant or entity (hereinafter “tenant”) information, such as an identifier of a provisioning entity, and/or a consuming entity identifier, and adding, to the event notifications, the tenant information. The tenant information may have been stored within the computing system, and may be mapped to particular identification information or other validating information within the event notifications. Furthermore, the gateway, or a different component of the computing system, may generate one or more messages in a standardized format, which may include relevant content from the event notifications such as events or event types and indications of any actions to be implemented or processed. These messages may be stored in a data structure such as a queue. If the data structure is inoperational or inactive, any messages generated may be uploaded to the data structure once the data structure becomes operational again. The messages may be dispatched or transmitted to be processed, for example, by the computing system. Such processing may occur within a walled garden of the computing system.

Next, the computing system may process each message from the data structure according to a modified first-in-first-out (FIFO) mechanism. The processing of each message may include validating a payload corresponding to the message and persisting the message into a datastore or database (hereinafter “database”), upon successful validation of the payload. The processing may further include deduplicating the message to determine whether a same or equivalent message, having a same event type, and the same entity information, is already present within the queue to await processing or has been processed, in order to avoid redundant processing. The processing may further include mapping an event type, as obtained from the message, to a specific workflow, APIs, and/or webhooks. For example, a specific event type such as a subscription creation may be mapped to a specific series of actions to be implemented, such as updating an internal status within the computing system, and/or interfacing with an external API or webhook to provision or unlock a particular resource corresponding to the subscription. The computing system may monitor up-to-date statuses related to processing, such as pending, ongoing processing, processed, or failed. Upon a failed status, reprocessing of or reattempting to process the message automatically or upon confirmation from an entity after the entity is notified regarding the failure. Because the message corresponding to the failed status is persisted in the database, reprocessing may be initiated by copying that message back into the data structure.

Embodiments of the invention implement a multi-tenant system. The multi-tenant system includes one or more hardware processors; and memory storing computer instructions. The computer instructions, when executed by the one or more hardware processors, are configured to perform storing product information in one or more databases. The product information defines subscription products available to subscribers of a tenant of the multi-tenant system and sources where subscriptions to the subscription products are available. The computer instructions, when executed by the one or more hardware processors, are further configured to store subscription information in the one or more databases. The subscription information includes subscriber identifiers, a tenant identifier, and subscription statuses of the subscription products. The computer instructions, when executed by the one or more hardware processors, are further configured to ingest, from the sources, event notifications of subscription updates to the subscription information, the event notifications indicating update types of the subscription updates. The computer instructions, when executed by the one or more hardware processors, are further configured to filter the event notifications based on the update types. The computer instructions, when executed by the one or more hardware processors, are further configured to validate respective sources of the event notifications, reformat the event notifications to a standardized format, generate messages corresponding to each of the reformatted, filtered and validated event notifications, store the messages within a data structure, map the messages to respective workflows based on the update types, and implement the workflows. In some embodiments, the messages within the data structure may be dispatched or transmitted from the data structure to be processed.

In some embodiments, at least a subset of the workflows comprise transmitting a webhook to an external system.

In some embodiments, the computer instructions when executed by the one or more hardware processors are further configured to perform generating and transmitting, to the tenant, a synchronized view of the subscription statuses of the subscription products across the sources, and wherein, the workflows comprise updating fields within the synchronized view corresponding to the event notifications.

In some embodiments, the computer instructions when executed by the one or more hardware processors are further configured to perform monitoring workflow statuses, wherein the workflow statuses indicate whether a workflow is pending, processing, completed, or has failed.

In some embodiments, the computer instructions when executed by the one or more hardware processors are further configured to perform: in addition to storing the messages within the data structure, storing, within the one or more databases, the messages; in response to a workflow status indicating that a first workflow corresponding to a first subscription product has failed, transmitting, to the tenant, an indication of the failed first workflow; receiving, from the tenant, an indication of an update to the product information; updating the product information according to the indication; and implementing the first workflow according to the first message and the updated product information.

In some embodiments, the filtering comprises filtering out any event notifications in which the corresponding update types are unmapped to any workflows.

In some embodiments, the event notifications comprise first event notifications from a first source and second event notifications from a second source, the first event notifications comprise a first format and the second event notifications comprise a second format, and the reformatting comprises converting, into the standardized format, the first event notifications and the second event notifications.

In some embodiments, the ingesting of the event notifications comprises ingesting the first event notifications into a first gateway and ingesting the second event notifications into a second gateway.

In some embodiments, the data structure comprises a queue.

In some embodiments, the event notifications comprise changes in the subscription statuses, and the messages indicate the tenant identifier and the update types.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a block diagram of a network system for providing cloud-based software-as-a-service (SAAS) services of a multi-tenant system to multiple tenants, according to some embodiments of the present invention.

FIG. 2 is a block diagram illustrating details of processing systems within the multi-tenant system, which may perform an operation of processing and synchronizing notifications from different sources. Such an operation may include ingesting notifications of events from different sources and processing the notifications into workflow actions, in accordance with some embodiments of the present invention.

FIG. 3 is a block diagram illustrating details of an ingesting engine, which performs obtaining of notifications from sources and other functions such as filtering, validating sources of the notifications, identifying events within the notifications, and controlling a rate of ingesting notifications, in accordance with some embodiments of the present invention.

FIG. 4 is a block diagram illustrating details of a message preparing engine, which reformats the notifications into a format that is message that is compatible with the server systems, and stores the message in a data structure and/or a data storage entity, in accordance with some embodiments of the present invention.

FIG. 5 is a block diagram illustrating details of a message processing engine, which performs processing of the messages, in accordance with some embodiments of the present invention.

FIG. 6 is a diagram illustrating details of an ingesting engine within a context of other functions, including generating messages and processing the messages, in accordance with some embodiments of the present invention.

FIG. 7 is a diagram that further illustrates an exemplary architecture of the message processing engine, in accordance with some embodiments of the present invention.

FIG. 8 is a block diagram illustrating details of a workflow executing engine, which performs executing of a workflow, in accordance with some embodiments of the present invention.

FIGS. 9A-9D are diagrams that illustrate interfaces that are generated by the workflow executing engine, in accordance with some embodiments of the present invention.

FIGS. 10-16 are flowcharts that illustrate details of processing messages corresponding to different event types, by the message processing engine, according to some embodiments of the present invention.

FIG. 17 is a flowchart illustrating details of a method of processing and synchronizing notifications from different sources, according to some embodiments of the present invention.

FIG. 18 is a block diagram illustrating details of a computing system.

### DETAILED DESCRIPTION

A claimed solution rooted in computer technology overcomes problems specifically arising in the realm of computer technology.

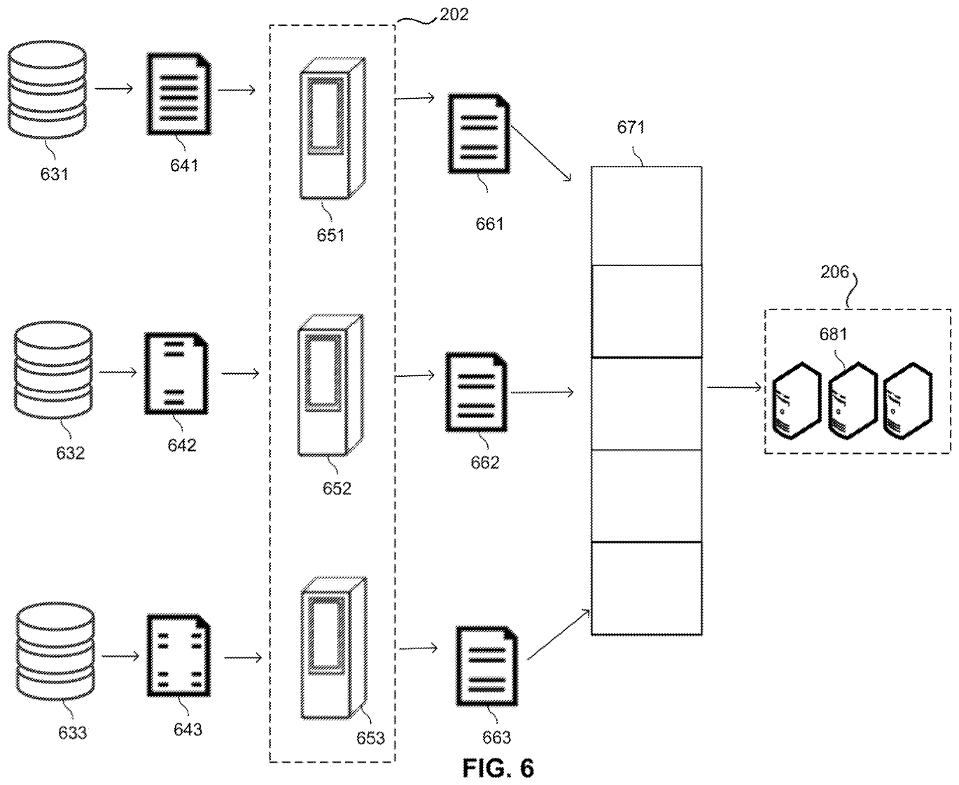

Embodiments of the invention implement one or more multi-tenant computing systems that perform synchronizing of notifications received from multiple sources and implementing of workflows in response to the notifications. The sources may include an application store and/or a server that hosts resources or products, such as subscription-based resources or subscription products. The notifications may be in a form of an API call, transmitted as a packet, which includes updates and/or status reports regarding the resources, including subscription-based statuses of the consuming entities. First, one or more gateways of the computing systems may ingest one or more event notifications. The event notifications may refer to subscription updates to subscription information. The event notifications may indicate update types of the subscription information. The subscription information may include subscriber identifiers, a tenant identifier, and subscription statuses of the subscription products. In some embodiments, to handle different validation protocols and/or formats of event notifications of the different sources, different gateways may ingest different event notifications depending on sources of the event notifications, as will be illustrated in FIG. 6. Each gateway may utilize a specific validation protocol and/or specific processing characteristics, and may be configured to ingest event notifications from a specific source. In such a manner, ingestion of event notifications from different sources may be handled efficiently in parallel across different gateways which are equipped to handle specific types, formats, and/or syntaxes of event notifications.

Upon ingesting the event notifications, the one or more gateways, and/or other components of the computing systems, may perform preliminary inspection and/or processing on the ingested event notifications. These steps may include parsing and/or decoding the ingested event notifications, and filtering out certain event notifications based on certain criteria, which may include event types of the event notifications. For example, event notifications that correspond to or indicate event types which do not trigger a downstream workflow, such as a billing-related workflow, may be filtered out in order to conserve processing resources. After filtering, the computing systems may validate sources of the remaining event notifications. The validating of the source may include validating access tokens (e.g., an Open Authorization (“OAuth”) token) and/or strings within the event notifications. For example, if a notification includes a token that matches a stored token within the one or more computing systems, then that notification may be validated. If the notification lacks such a token, then the validation may occur via other means such as other identification information, including keys (e.g., private keys) username, and/or password. After validating, the computing systems may retrieve tenant information (e.g., a provisioning entity) and/or a consuming entity pertaining to the event notifications. The computing systems may also retrieve event identifiers of the event notifications, which identify event types. The tenant information and the event identifiers may subsequently be appended to or included within messages that are generated from the event notifications.

In some embodiments, the computing systems may control a rate in which the event notifications are ingested. The computing systems may limit an overall rate, or a per-tenant rate, of the event notifications. For example, the computing systems may impose a per-tenant limitation, which may be detected based on internet protocol (IP) addresses. The computing systems may detect event notifications received from different IP addresses. If a rate of event notifications from a specific IP address and/or from a specific group of IP addresses exceeds a threshold, the computing systems may throttle that specific IP address or group of IP addresses until a subsequent timeframe. In some examples, notification rates or counts may be tracked by a key-value store used to cache the event notifications that pass through the gateway. An example of such a key-value store includes a Remote Dictionary Server (Redis).

In some embodiments, the computing systems may reformat the event notifications into messages, which have a standardized format and/or syntax that is recognizable upon processing. The computing systems may append the previously retrieved tenant information and the event identifiers to the messages, if absent from the event notifications. The computing systems may store the messages within a data structure, such as a queue. In some examples, even when the data structure is inactive and/or inoperational, the computing systems may still ingest the event notifications and reformat the event notifications into messages. In such a scenario, the computing systems may store the messages into the data structure once the data structure becomes operational.

In some embodiments, a service may forward the messages to an event processor or message processor (hereinafter “event processor”) of the computing systems, which performs processing of the messages. The event processor may reside within a different environment, in particular, a walled garden or a secured environment of the computing systems, and may not be able to automatically retrieve information from outside of the walled garden. Confining such steps within a walled garden may enhance security of the processing of the messages. For example, certain sensitive information may be revealed during the processing, and such sensitive information may be confined within a secured environment to prevent unauthorized or undesired dissemination.

The event processor may include a service that validates payloads of the messages, and stores the messages into a database (as distinguished from the previous key-value store) upon validating the payloads. The database may include a MySQL database, which may be organized according to each tenant and each schema in order to isolate each tenant's data. The event processor may check for any duplicate messages that are being processed or have been processed, monitors statuses of processing the messages, and maps the messages to particular workflows to be implemented. The workflows may include triggering or initiating a process to provision resources, change permissions of resources, or implementing a process such as a billing process. For example, the workflows may include transmitting a message to a source that a resource is ready to be provisioned or unlocked.

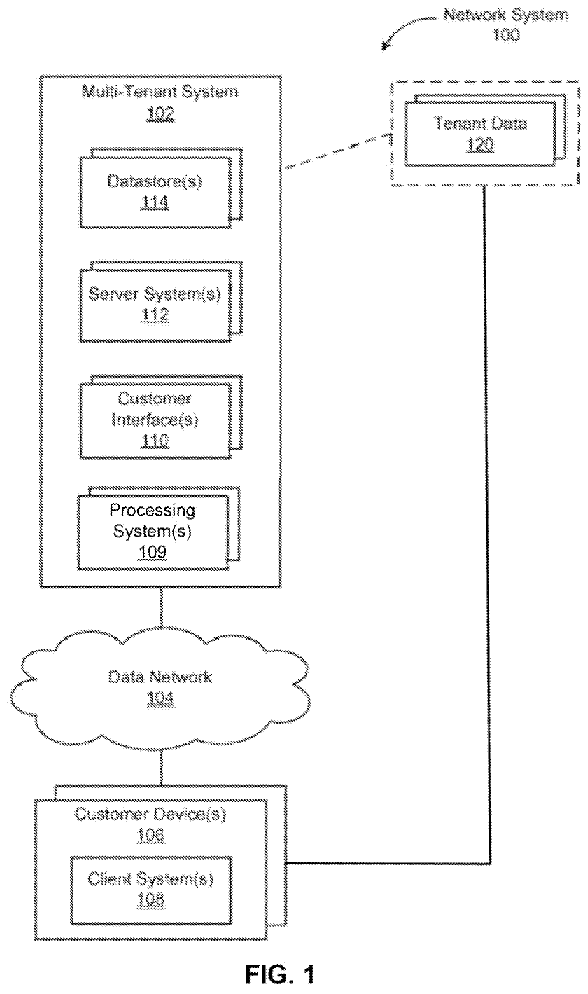

FIG. 1 depicts a diagram of an example network system 100 for providing cloud-based software-as-a-service (SAAS) services of a multi-tenant system 102 to multiple tenants according to some embodiments. Examples of the cloud-based SAAS services include data storage, data processing, and business-oriented applications. In some embodiments, each tenant may be a provisioning entity, such as a subscription-based entity or provider of resources (e.g., an internet service provider, a home security system and service provider, a cellular phone service provider, or entertainment content provider). Each tenant may additionally or alternatively include a group of one or more users (e.g., individuals, business entities, customers of the business entities, systems) who share access to the cloud-based services. In one embodiment, a tenant includes a service entity such as AT&T, Netflix, Verizon, and/or the like. A tenant may include one or more products or services of an entity. For example, AT&T internet products may be a particular tenant, and AT&T security products may be another tenant. In some embodiments, the cloud-based SAAS services relate to managing subscriber records, product and/or service consumption information, billing information, payment information, and/or the like.

The network system 100 includes the multi-tenant system 102 coupled via a data network 104 (e.g., a set of one or more public and/or private, wired and/or wireless networks) to client devices 106. The multi-tenant system 102 includes shared resources to host the cloud-based SAAS services to the tenants. The shared resources may include processors, memory, virtual systems, services, application programs, load balancers, firewalls, and/or the like. As shown, the multi-tenant system 102 includes tenant interfaces 110, server systems 112, datastores 114, and processing systems 109. Each of the client devices 106 includes a client system 108 that accesses the cloud-based SAAS services hosted by the multi-tenant system 102. In some embodiments, the client systems 108 may be operated by employees (e.g., administrator users) of the provider of the multi-tenant system 102. In some embodiments, the client systems 108 may be operated by employees of the tenant. In some embodiments, the client systems 108 may be operated by end users of the tenant's services.

Each client device 106 may include a desktop, laptop, notebook, tablet, personal digital assistant, smart phone, or other consumer electronic devices incorporating one or more computer components. The client system 108 on each client device 106 may include hardware, software and/or firmware for communicating with the multi-tenant system 102 and accessing the cloud-based services it hosts. Examples of the client systems 108 may include web browsers, client engines, drivers, user interface components, proprietary interfaces, and/or the like.

The multi-tenant system 102 includes hardware, software and/or firmware to host the cloud-based services for the tenants. It will be appreciated that the typical multi-tenant system 102 may offer access to shared resources including systems and applications on shared devices and offer each tenant the same quality or varying qualities of service. In some embodiments, the multi-tenant system 102 does not use virtualization or instantiation processes. In some embodiments, a multi-tenant system 102 integrates several business computing systems into a common system with a view toward streamlining business processes and increasing efficiencies on a business-wide level.

In some embodiments, the multi-tenant system 102 includes a user interface tier of multiple tenant interfaces 110, a server tier of multiple server systems 112, and a datastore tier of multiple datastores 114 for the multiple tenants. In some embodiments, the tenant interfaces 110 includes graphical user interfaces and/or web-based interfaces to enable tenants to access the shared services hosted by the multi-tenant system 102. The tenant interfaces 110 may support load balancing when multiple tenants (and/or multiple customers of the tenants) try to access the multi-tenant system 102 concurrently. The tenant interfaces 110 may additionally or alternatively include an operator interface for use by a systems operator to configure or otherwise manage the multi-tenant system 102. In some embodiments, each tenant may be associated with a subset of the total tenant interfaces 110 for load balancing.

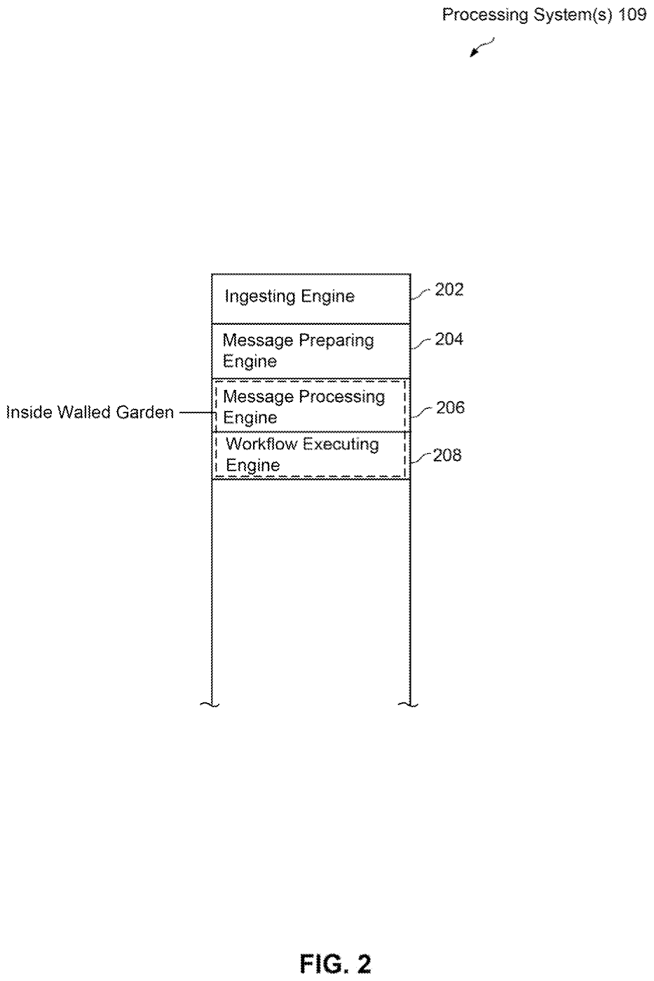

In some embodiments, the server systems 112 include hardware, software and/or firmware to host the shared services for tenants. The hosted services may include tenant-specific business services or functions, including enterprise resource planning (ERP), customer relationship management (CRM), eCommerce, Human Resources (HR) management, payroll, financials, accounting, calendaring, order processing, subscription billing, inventory management, supply chain management (SCM), collaboration, sales force automation (SFA), marketing automation, contact list management, call-center support, web-based customer support, partner and vendor management systems, product lifecycle management (PLM), financial, reporting and analysis, and/or the like. Similar to the tenant interfaces 110, in some embodiments, the server systems 112 may support load balancing when multiple tenants (and/or multiple customers of tenants) try to access the multi-tenant system 102 concurrently. Further, in some embodiments, each tenant may be associated with a subset of the total server systems 112 for load balancing. In some embodiments, the processing systems 109 include hardware, software and/or firmware to perform ingesting event notifications from different sources, formatting the event notifications into messages, processing the messages, mapping the messages, or event types extracted from the messages, to downstream actions such as workflows, and implementing the workflows, as will be further elucidated in FIGS. 2-8, 9A-9D, and 10-17. In some embodiments, the processing systems 109 may perform the actions of the previously described event processor.

In some embodiments, tenant data 120 for each tenant may be stored in a logical store across one or more datastores 114. In some embodiments, each tenant uses a logical store that is not assigned to any predetermined datastores 114. Each logical store may contain tenant data 120 that is used, generated and/or stored as part of providing tenant-specific business services or functions. In some embodiments, the datastores 114 may include relational database management systems (RDBMS), MySQL relational database systems, object-based database systems, and/or the like. In some embodiments, tenant data 120 may be stored across multiple datastores 114, with each datastore dedicated to a particular service (e.g., managing customer records, managing subscription data, managing product and/or service consumption information, managing billing information, managing payment information, and/or the like). In some embodiments, any of the datastores 114 may store information regarding any event notifications, messages, and/or any outputs resulting from processing of the messages. In some examples, the tenant data 120 may originally have been ingested into the datastores(s) 114 from different sources (e.g., servers that host resources being provisioned by a tenant).

In some embodiments, the tenant data 120 may include information regarding resources that are distributed to consuming entities. The information may include statuses of the resources (e.g., which consuming entities are subscribed to the resources), and a provisioning entity (e.g., tenant or tenant identifier) that coordinates distribution of the resources. In some embodiments, the tenant data 120 may include subscription data, such as billing data, subscription status (e.g., active, canceled, suspended, re-activated), and/or geospatial data. Billing data may include billing invoice data (e.g., date of invoices and invoice amounts, overage charge dates and overage charge amounts), payment transaction data (e.g., date of payments, amount of payments), payment methods (e.g., credit card, debit card), payment plan (e.g., annual billing, monthly billing), and/or service plan information (e.g., the name of a service plan). Subscription information may also include a geographic region and/or location associated with a tenant, service, and/or subscriber. In some embodiments, the tenant data 120 may include usage data (e.g., account activity data), such as new subscriptions, changes to subscribed products and/or services, cancellation of one or more products and/or services, subscriptions to new products and/or services, application of discounts, loyalty program package changes (e.g., additional programs and/or services, special rates, and/or the like for loyal customers), reduction or increase of rates for products and/or services, and/or cancellation of the application. In some embodiments, account activity may include usage of a product and/or product of a subscriber (e.g., what programs or content the subscriber actually watches, what services and what level of consumption the subscriber receives, quality of the product and/or services, and/or the like).

In some embodiments, the tenant data 120 may be stored in one or more data formats (or, simply, formats). For example, subscription tenant data may be stored in a particular format, and usage tenant data may be stored in another format. As used herein, formats may include data types, variable types, protocols (e.g., protocols for accessing, storing, and/or transmitting data), programming languages, scripting languages, data value parameters (e.g., date formats, string lengths), endpoint locations and/or types, and/or the like.

In some embodiments, the tenant data 120 may be stored in one or more monolithic databases and in one or more custom field databases. As stated above, the tenant data 120 may be stored in different records, e.g., a subscription record, a usage record, a billing record, etc. Each record may be managed by a particular record object, e.g., a subscription record object, a usage record object, a billing record object, etc. Each record object may manage a number of global fields that are common to all of the tenants. For example, the global fields for a subscription record for each and every tenant may include record ID, a username, a subscription identifier, etc. The global fields may be stored in the monolithic database. Notably, different tenants may require different additional fields to store information for different record objects. For example, a first tenant may require two custom fields for a subscription record and one custom field for a usage record. Another tenant may require three custom fields for a subscription record and four custom fields for a usage record. Data for these custom fields can be stored in a custom field database for each record for each tenant.

The monolithic and custom field databases of the multi-tenant system 102 may manage (e.g., create, read, update, delete) tenant data 120 using different formats, different protocols, etc. A monolithic application will control data storage in the monolithic database. A custom field service (microservice) will control data storage in the custom field database. It will be appreciated that as used herein, a “service” may be single service and/or a set of services (e.g., a cluster of services).

The data network (or, communication network) 104 may represent one or more computer networks (e.g., LAN, WAN, or the like) or other transmission mediums. The data network 104 may provide communication between the systems, engines, datastores, components, and/or devices described herein. In some embodiments, the data network 104 includes one or more computing devices, routers, cables, buses, and/or other network topologies (e.g., mesh, and the like). In some embodiments, the data network 104 may be wired and/or wireless. In various embodiments, the data network 104 may include the Internet, one or more wide area networks (WANs) or local area networks (LANs), one or more networks that may be public, private, IP-based, non-IP based, and so forth.

FIG. 2 is a block diagram illustrating details of the processing systems 109, in accordance with some embodiments of the present invention. The processing systems 109 include an ingesting engine 202, a message preparing engine 204, a message processing engine 206, and a workflow executing engine 208.

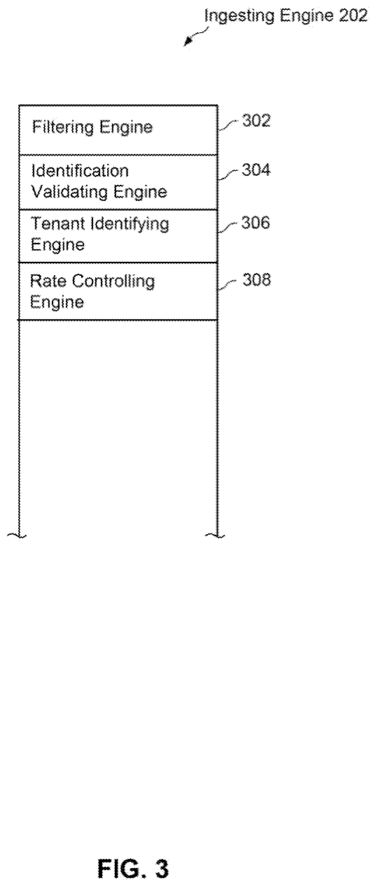

The ingesting engine 202 includes hardware, software and/or firmware capable of communicating with the tenant interfaces 110, the client devices 106, and/or other computing interfaces or APIs, to ingest event notifications of events from different sources. The ingesting of event notifications may be from sources such as other servers (e.g., provisioning servers), and/or may be through other channels such as a non-native channel or source configured specifically by a tenant to transmit event notifications to the ingesting engine 202. The ingesting engine 202 may be implemented by one or more gateways of the processing systems 109. Each gateway of the processing systems 109 may be configured to ingest event notifications from one or more specific sources, and/or of one or more specific formats. Each gateway of the processing systems 109 may have listeners (e.g., Java-based listeners), interfacing with one or more sources, to detect any new event notifications. The listeners are arranged based on region and/or environment. Here, an environment may refer to a testing or sandbox environment, or production environment. Thus, upon a source receiving a notification of an event, a listener detects that source having received a notification, and the ingesting engine 202 ingests the notification via an API call. If ingestion fails, then the ingesting engine 202 may reattempt ingestion of the event notifications. The ingesting engine 202 may perform decoding, parsing, filtering, and validating sources of the event notifications, as will be described with respect to FIG. 3.

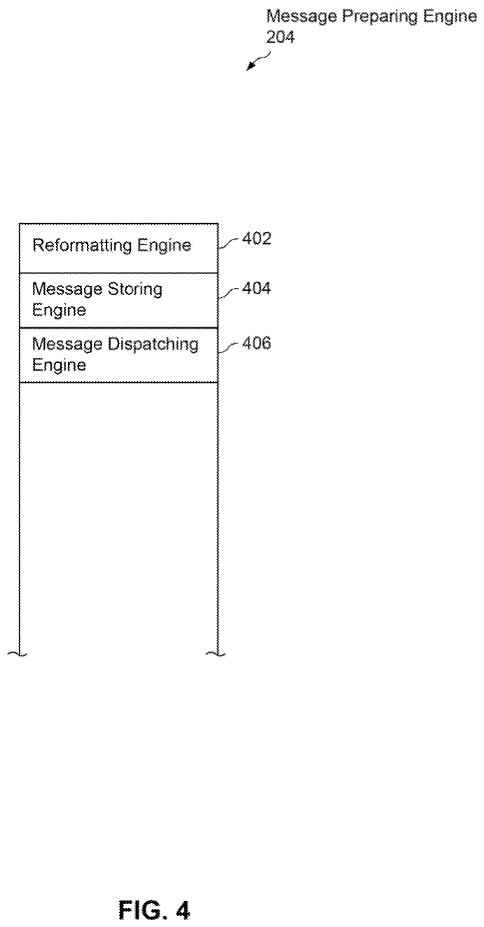

As will be further described with respect to FIG. 4, the message preparing engine 204 includes hardware, software and/or firmware capable of generating messages from the respective event notifications, storing the messages within a database, and transmitting the messages to the message processing engine 206 to be processed. The generating of the messages may include reformatting the event notifications to be compatible and readable by the message processing engine 206, and appending certain identifying information such as an event identifier, an event type, and/or a tenant identifier, if absent from the event notifications. The tenant identifier may include a provisioning tenant identifier and/or a consuming tenant identifier. The message preparing engine 204 may standardize event notifications that were previously in different formats into a standardized message.

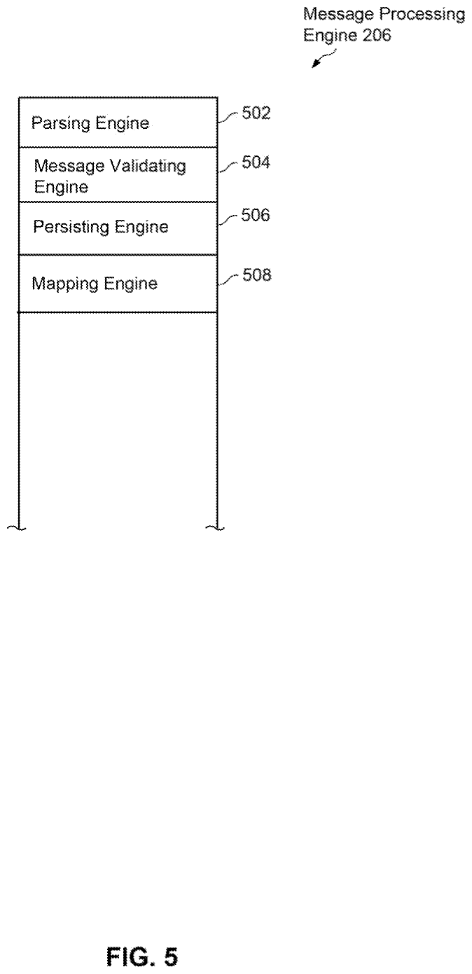

As will be further described with respect to FIG. 5, the message processing engine 206 includes hardware, software and/or firmware to process a message transmitted by the message preparing engine in order to map the message to one or more downstream workflows. The message processing engine 206 may be implemented, either partially or entirely, within a secured environment such as a walled garden. In some examples, the message processing engine 206 validates a payload of the message to verify a validity of the message. The message processing engine 206 may persist the message into a database and deduplicate the message to check whether a different message with a same content is currently being processed or has been processed. The message processing engine 206 may extract an event type from the payload of the message and map the event type to one or more workflows.

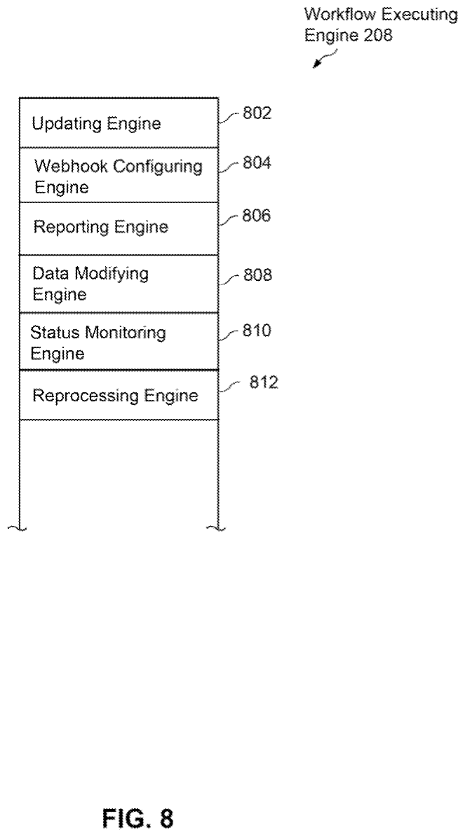

As will be further described with respect to FIG. 8, the workflow executing engine 208 includes hardware, software and/or firmware to execute workflow operations. The workflow executing engine 208 may be implemented, either partially or entirely, within the secured environment. The workflow operations may include interfacing with different external APIs or webhooks to perform a downstream action. The workflow operations may include provisioning a resource to a consuming entity, modifying access attributes of a resource to a tenant (e.g., a consuming entity), modifying data, and/or monitoring or generating additional data or metrics, such as those related to the event type. The workflow executing engine 208 may monitor statuses of processing of a message and/or execution of a workflow. The statuses may include 1) pending, indicating that the workflow has not commenced, 2) currently processing, indicating that the workflow has commenced but not completed, 3) processed, indicating that a workflow has completed processing, and 4) failed, indicating that execution of a workflow was unsuccessful.

Referring to FIG. 3, the ingesting engine 202 includes a filtering engine 302, an identification validating engine 304, a tenant identifying engine 306, and a rate controlling engine 308. Thus, the ingesting engine 202 may perform preliminary inspection of any event notifications ingested.

The filtering engine 302 includes hardware, software and/or firmware capable of filtering out event notifications depending on certain criteria. This criteria may include, in some examples, event types corresponding to and/or described within the event notifications. Thus, upon the filtering engine 302 detecting an event type, if the event type does not map to any existing workflow (e.g., a billing workflow) then the filtering engine 302 may restrict or prohibit the notification from further processing, meaning that the notification would be restricted from passing to the identification validating engine 304, to the message generating engine 204 and/or the message processing engine 206. Examples of event notifications that fail to map to any existing workflow may include a notification of a continued subscription, or a confirmation of an already scheduled process that has already been implemented in a workflow. Examples of confirmations may include a confirmation of a change in an attribute of a resource, such as a duration and/or a price, or that a subscription of a consuming entity has expired or is scheduled to expire, when such an expiration was already previously processed. In such a manner, the filtering engine 302 prevents wasteful processing of any event notifications that would not trigger any workflow processes. The filtering engine 302 may only permit further processing of certain event notifications, such as event notifications of update types that actually map to existing workflow processes.

The identification validating engine 304 includes hardware, software and/or firmware capable of verifying that any ingested event notifications have a proper and recognized source. For example, the identification validating engine 304 may validate a source (e.g., a specific server) from which the event notifications were obtained, based on identification information within the event notifications. The identification information may be within headers of the event notifications. Upon determining that the identification information corresponds to stored identification information within the multi-tenant system 102, the identification validating engine 304 may confirm a validity of a source of the event notifications. The identification information may include any or all of a token, a string, a name (e.g., username), and a password. However, if the identification validating engine 304 fails to recognize identification information as corresponding to stored identification information within the multi-tenant system 102, the identification validating engine 304 may fail to validate the source from which the event notifications were obtained. If the identification validating engine 304 fails to validate the source of a notification, then the identification validating engine 304 may block the notification from being further processed. In such a manner, the identification validating engine 304 may implement a first level of security to mitigate possibilities of a rogue notification arising from an unknown source, without inspecting payloads.

The tenant identifying engine 306 includes hardware, software and/or firmware capable of identifying a tenant associated with the event notifications. In some examples, the identification of a tenant may be based on identification information within the event notifications and/or retrieval of stored identification information within the multi-tenant system 102. For example, the tenant identifying engine 306 may either directly or indirectly obtain tenant information from the event notifications. If the tenant identifying engine 306 indirectly obtains the tenant information from the event notifications, the tenant identifying engine 306 may first obtain identification information, such as a password or key, from the event notifications, which may not directly identify a tenant. The tenant identifying engine 306 may map the obtained identification information to tenant information stored within the multi-tenant system 102, in order to indirectly obtain the tenant information.

The rate controlling engine 308 includes hardware, software and/or firmware capable of controlling a rate at which event notifications are ingested. The rate may specify an upper bound or an upper limit of event notifications to be ingested per given period of time. The rate may refer to an overall rate across all tenants, such as an overall limit of a particular number of event notifications per second. Additionally or alternatively, the rate may refer to a specific rate for each tenant or a given tenant, such as a limit of a particular number of event notifications per second for each tenant. The rate controlling engine 308 may enforce such a tenant-specific limit using an IP based rate limitation. For example, the rate controlling engine 308 may monitor a number of event notifications over a given period of time received from different IP addresses. If the rate controlling engine 308 detects that a number of event notifications over that given period of time from a specific IP address and/or from a specific group of IP addresses exceeds a threshold, the rate controlling engine 308 may throttle that specific IP address or group of IP addresses for a reminder of that given period of time. The rate controlling engine 308 not only controls an amount of traffic, but may also prevent an attack such as a denial of service (DOS) attack. In some examples, a number of event notifications may be tracked by a key-value store, such as Redis, that is used to cache the event notifications that pass through the gateway.

In some examples, the rate controlling engine 308 may adjust the aforementioned overall and/or tenant-specific limits depending on overall traffic. For example, during periods at which traffic increases, the rate controlling engine 308 may increase overall and/or tenant-specific limits. Conversely, during periods at which traffic decreases, the rate controlling engine 308 may decrease overall and/or tenant-specific limits. In some examples, the rate controlling engine 308 may, during periods at which traffic increases, configure or active additional gateways to handle the increased traffic.

Referring to FIG. 4, the message preparing engine 204 includes a reformatting engine 402, a message storing engine 404, and a message dispatching engine 406.

The reformatting engine 402 includes hardware, software and/or firmware capable of reformatting, appending data to, and/or removing data from, a notification that was ingested by the ingesting engine 202. The reformatting engine 402 may convert the notification into a message which has a standardized format that is recognizable by the message processing engine 206. In some examples, the reformatting engine 402 may decode one or more portions of a payload from a notification, recognize incomplete or missing information, and request supplemental information, for example, from a source at which the notification was received. Examples of the supplemental information may include more detailed event information. For example, initially, the notification may indicate that an event is a change subscription event, but may not indicate whether the change in subscription is an upgrade or a downgrade. In such a scenario, the reformatting engine 402 may request such supplemental information from the source, and upon receiving the supplemental information, append the supplemental information into the message.

The message storing engine 404 includes hardware, software and/or firmware capable of storing a message to a data structure such as a queue, which schedules the message for processing by the message processing engine 206. The data structure may include scheduled messages from different tenants. In some examples, the data structure may be flexibly modified based on overall traffic and/or per-tenant traffic, as measured by rate or amount of event notifications. For example, if a particular tenant experienced high traffic, then the data structure may be modified to dedicate a separate queue to that particular tenant, in order to mitigate delays on other tenants. In some examples, if a separate queue is dedicated to that particular tenant, a number of processors or an amount of computing resources dedicated to that particular tenant may remain unchanged.

The message dispatching engine 406 includes hardware, software and/or firmware capable of dispatching or transmitting a message from the queue to be processed by the message processing engine 206. The message dispatching engine 406 may arrange an order of processing messages based on a modified FIFO mechanism. The modifications to the FIFO mechanism may include considerations such as load balancing based on volumes of each of the tenants, and/or event types described within the messages. For example, modifications due to load balancing may entail switching order of processing messages in order to balance a number of messages or an amount of computing resources consumed by processing messages across different tenants, to prevent one single tenant from consuming a disproportional amount of the processing resources within a given period of time. Therefore, the message dispatching engine 406 may delay processing of certain messages from a given tenant if that tenant has exceeded some threshold number of messages within a given period of time. Meanwhile, modifications due to event type may include rearranging an order of processing such that certain combinations of messages are processed sequentially or concurrently. One example occurs when a change subscription event is actually manifested as two separate messages, a cancellation and a renewal. Yet another example occurs when a renewal event is actually manifested as two separate messages, a cancellation and a new subscription. In such scenarios, the two separate messages actually correspond to a single event and thus are to be processed sequentially or concurrently. Therefore, the message dispatching engine 406 may reorder two such separate messages so that they are processed sequentially or concurrently, even when the two separate messages are originally separated by other intervening messages, such as a cancellation and a renewal corresponding to a same consuming entity identifier being separated by an intervening cancellation corresponding to a different consuming entity identifier. The message dispatching engine 406 may further provide an indication to the message processing engine 206 that numerous messages are to be processed sequentially or concurrently in such a scenario. In some examples, the message dispatching engine 406 may combine or consolidate two separate messages that are to be processed in tandem.

Referring to FIG. 5, the message processing engine 206 includes a parsing engine 502, a message validating engine 504, a persisting engine 506, and a mapping engine 508. In some examples, the message processing engine 206 may be implemented as the aforementioned event processor.

The parsing engine 502 includes hardware, software and/or firmware capable of parsing a message in order to identify relevant features of the message. The parsing engine 502 may identify a payload of the message, and from the payload, an event type. Next, the message validating engine 504 includes hardware, software and/or firmware capable of validating a message, including a payload, to detect any potentially fraudulent messages. For example, the message validating engine 504 may validate receipt information provided within the payload by comparing the receipt information with that stored in a source from which the notification came. As another example, the message validating engine 504 may validate an event type by confirming with a source that a proper payment was received, or other modification was made at the source to confirm the event type. For example, if a renewal is associated with a payment, then the message validating engine 504 may confirm that the payment was received at the source. As another example, the message validating engine 504 may check a validity of a message based on any time signatures. For example, the message validating engine 504 may check the time signatures against times recorded at the source. If a deviation between the time signatures and the recorded times at the source exceed a threshold deviation, then the message validating engine 504 may determine that the message is potentially fraudulent. If the message validating engine 504 determines that a message is fraudulent, or potentially fraudulent, then the message validating engine 504 may prevent and/or refrain from further processing on the message.

In some examples, the message validating engine 504 may also determine whether the message includes a duplicate event. For example, if an event identifier of the message matches that of a different message which is already awaiting processing, being processed, or has been processed, then the message validating engine 504 determines that the message includes a duplicate event. In other examples, the message validating engine 504 may determine that the message includes a duplicate event based on a match between other identification information within the message, and a different message. For example, the message validating engine 504 may determine that the message has a same event type, and common entity information (e.g., tenant and consuming entity) within a same time window as that of a different message. The message validating engine 504 may prevent a message that includes a duplicate event from further processing.

The persisting engine 506 includes hardware, software and/or firmware capable of persisting the message into a database, such as the datastores 114, associated with the multi-tenant system 102, upon the message validating engine 504 determining that the message is valid. Because the message is persisted into the database, in an event that the processing of the message fails, then the message may be retried without having to regenerate the message. Next, the mapping engine 508 includes hardware, software and/or firmware capable of mapping an event type, as identified within the message, to a particular workflow. Such a mapping may be determined based on workflows stored within the multi-tenant system 102, and stored relationships between event types and workflows within the multi-tenant system 102, and/or defined relationships between event types and workflows by a particular tenant.

Next, FIG. 6 is a diagram that provides a summary and further clarification regarding the processes illustrated in FIGS. 2-5. In particular, FIG. 6 clarifies how the ingesting engine 202 handles and recognizes event notifications of different formats and/or syntaxes while reformatting the event notifications to have a standardized format to facilitate further processing. Each of gateways 651, 652, and 653, which may include API gateways, may perform functions of the ingesting engine 202. Each of the gateways 651, 652, and 653 may ingest respective event notifications 641, 642, and 643 from different sources 631, 632, and 633, respectively. In particular, each of the sources 631, 632, and 633 may be programmed to generate a particular format and/or syntax of event notifications. Each of the gateways 651, 652, and 653 may be programmed to recognize and/or be compatible with a certain syntax and/or format. Thus, each of the gateways 651, 652, and 653 may be limited to ingesting only event notifications that are recognizable, and/or efficiently processed by that gateway. Each gateway 651, 652, and 653 may implement functions described with respect to the ingesting engine 202, and may perform decoding, parsing, and source validating the event notifications, as described previously, for example in FIGS. 2 and 3. In addition, as described in FIG. 4, each of the gateways 651, 652, and 653, and/or other components of the processing systems 109, may reformat the event notifications 641, 642, and 643. The gateways 651, 652, and 653 may append any missing identification information to the event notifications 641, 642, and 643, to generate messages 661, 662, and 663, which have a standardized format. This standardized format is recognizable, compatible, and readily processed by the processing systems 109, in particular, event processors 681, which may be implemented as the message processing engine 206 as described in FIGS. 2 and 5. A data structure 671, such as a queue, may store the messages 661, 662, and 663, along with other messages that await processing.

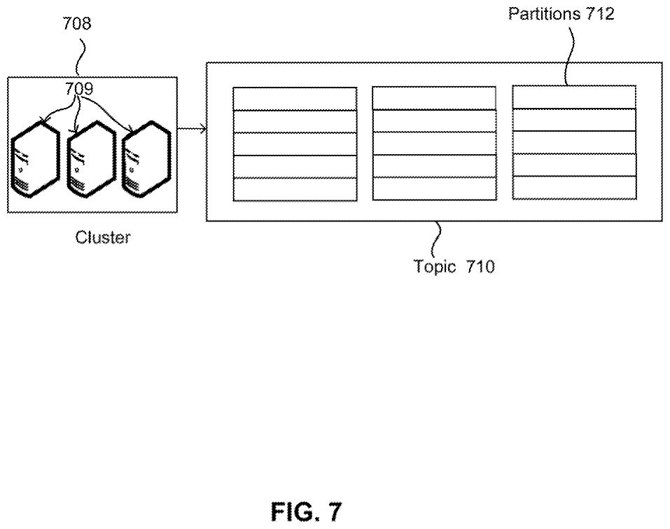

FIG. 7 is a diagram that illustrates an example architecture of the message processing engine 206. In some examples, the message processing engine 206 may be implemented by a group of topic divided clusters 708. The topic divided clusters 708 may include collaborative servers, such as brokers 709, that facilitate speed, durability, and scalability. The topic divided clusters 708 may process different data differentiated on a basis of topics 710 and partitions 712. Here, a topic may include all event notifications or messages received from different tenants. Such an architecture may be scalable depending on load. For example, during times of higher load, a number of servers (e.g., the brokers 709) may be increased, and/or a topic may be modified to be a smaller subset of the original topic, such as event notifications or messages from a specific tenant or group of tenants.

Next, referring to FIG. 8, the workflow executing engine 208 may execute workflows that have been mapped to event types according to the message processing engine 206. The workflow executing engine 208 includes an updating engine 802, a webhook configuring engine 804, a reporting engine 806, a data modifying engine 808, a status monitoring engine 810, and a reprocessing engine 812. Depending on an event type, the workflow executing engine 208 may perform different workflow actions.

The updating engine 802 includes hardware, software and/or firmware capable of providing status updates to tenants and/or other entities (e.g., third parties) or computing systems regarding workflow operations. For example, the updating engine 802 may update tenants by confirming that a workflow operation has been completed, or has failed. The status updates may not be sent directly to a device of a tenant, but rather, indirectly transmitted to the source, which may forward the updates to the tenant. In some examples, the updating engine 802 may be configured to provide updates through different communication means, including electronic mail or Short Message Service (SMS). Next, the webhook configuring engine 804 includes hardware, software and/or firmware capable of configuring a webhook or an API at an external computing system. As a result, the webhook configuring engine 804 may facilitate any status updates regarding event notifications and/or workflow operations to be transmitted to the external computing system.

The reporting engine 806 includes hardware, software and/or firmware capable of performing generating and transmitting of reports. For example, the reports may include a unified view, which may be manifested as a dashboard, regarding overall statuses or other aspects of event notifications and/or workflow operations across different sources for a specific tenant. The reporting engine 806 may generate reports that audit certain aspects of the event notifications and/or workflow operations, such as success rates and/or efficiencies of the workflow operations. The data modifying engine 808 includes hardware, software and/or firmware capable of performing modifications to existing data fields, such as those in databases or within a report. For example, values within certain data fields may be appended to an existing report generated. These fields may then be populated onto any transmitted view, such as a dashboard.

The status monitoring engine 810 includes hardware, software and/or firmware capable of performing monitoring of statuses of workflow operations. In particular, the status monitoring engine 810 may monitor whether a workflow operation is pending, currently being processed, completed processing, or has failed. In the event of a failure, the reprocessing engine 812 includes hardware, software and/or firmware capable of reprocessing a failed workflow operation. The reprocessing engine 812 may identify a reason of a failure, if identifiable, transmit the reason and an indication of the failure to a tenant, for example, indirectly via a source, and receive a modification by the tenant. After receiving the modification, the reprocessing engine 812 may execute, or coordinate the execution of, the workflow operation again, or a different workflow operation. For example, if a resource indicated by a message is not stored within the multi-tenant system 102, the tenant may add the resource to a database of the multi-tenant system 102. In an event that a reason of a failure is unidentifiable, the reprocessing engine 812 may reattempt the workflow operation.

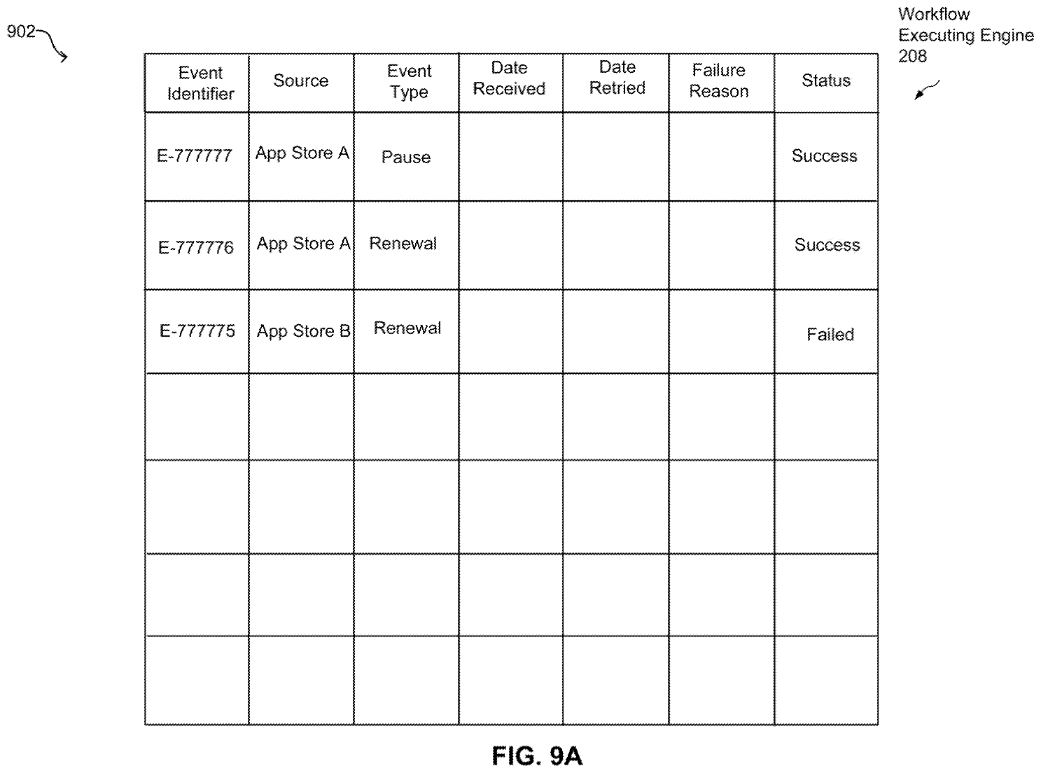

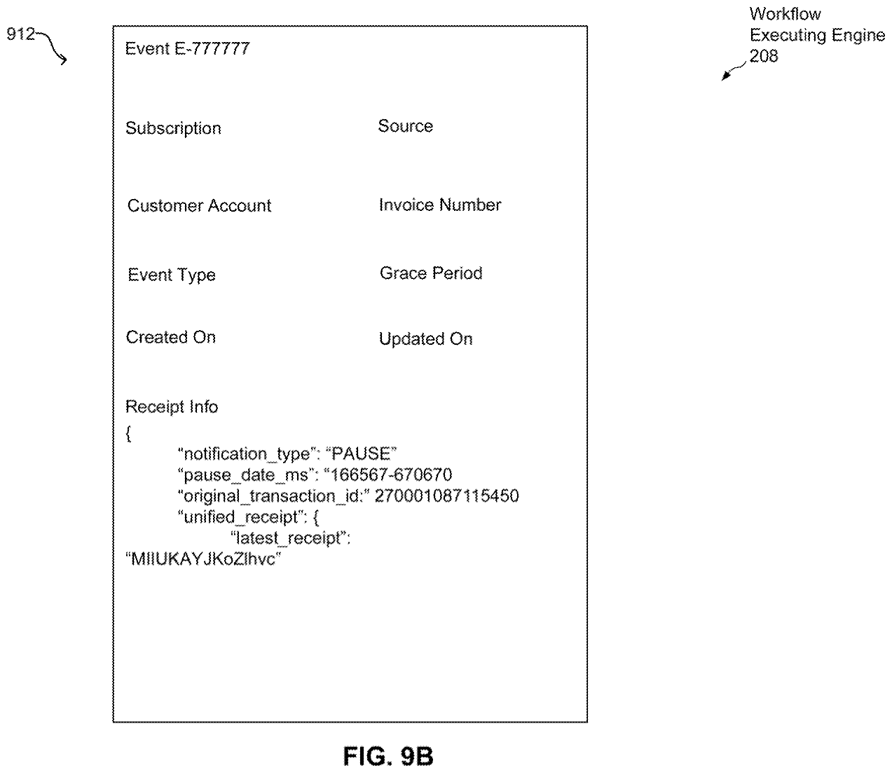

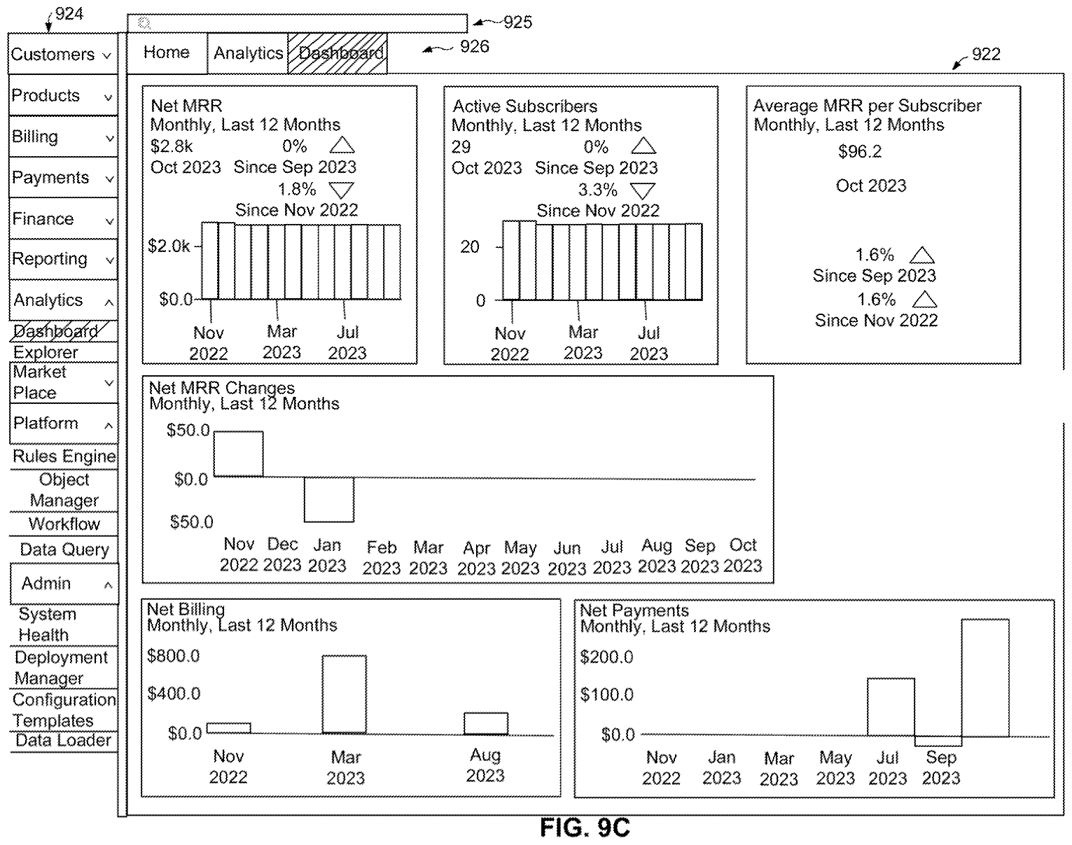

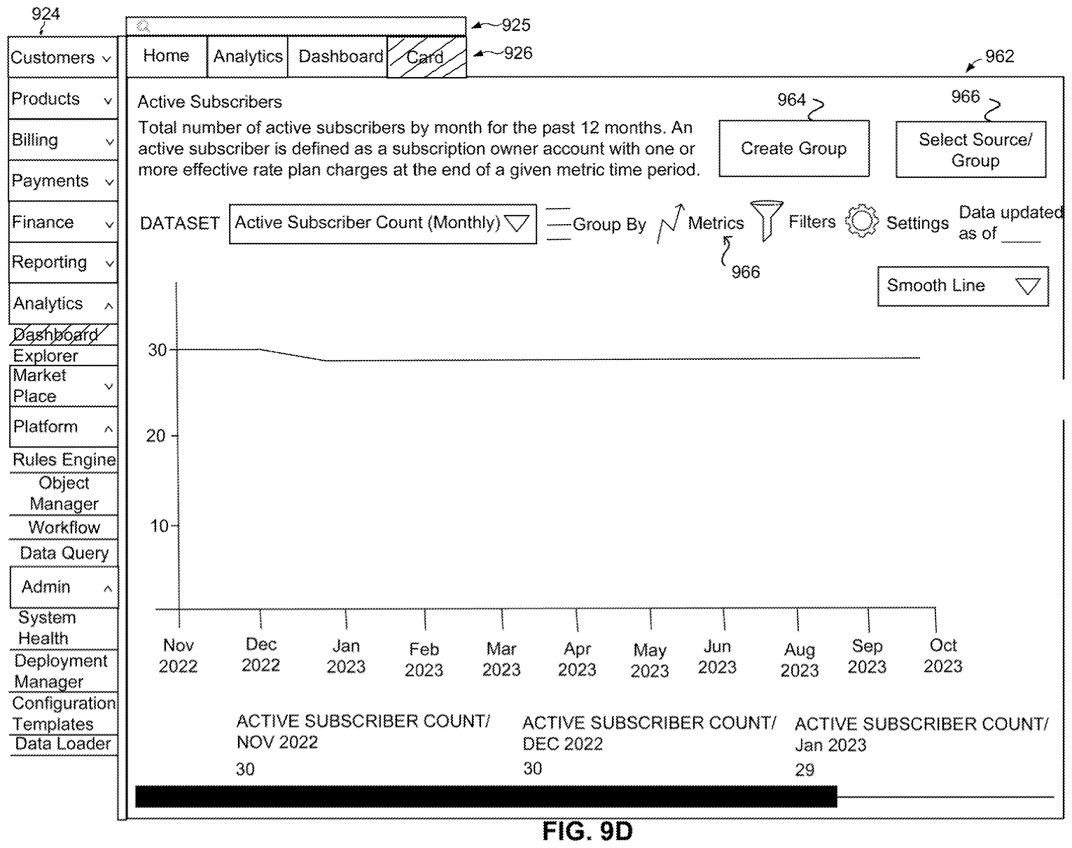

FIGS. 9A, 9B, 9C, 9D, and 10-16 illustrate example implementations of the workflow execution engine 208. FIGS. 9A-9D include example interfaces or dashboards generated to be displayed, populated, or provided (hereinafter “displayed”) on a device (e.g., any of the client devices 106).

FIGS. 9A and 9B illustrate example interfaces or dashboards generated to provide a unified view of messages for events originating from different sources. In FIG. 9A, the workflow executing engine 208, in particular, the reporting engine 806, may generate a report 902 to be populated on an interface or dashboard. The report 902 may indicate event identifiers of messages, sources from which the events originated or arose, event types, dates and/or times the events were ingested, current statuses of a workflow operation (e.g., whether the workflow operation is pending, successful, or has failed), reasons for any failure of the events, and dates that the workflow operation was retried after a failure. In FIG. 9B, the reporting engine 806 may generate a detailed report 912 including specific information regarding an event within the report 902, in response to receiving a selection of a specific event within the report 902. The detailed report 912 may include a subscription affected by the event, a source, a specific account of a customer (e.g., consuming entity), an invoice number, an event type, a grace period (e.g., before an action due date, such as a payment due date), a date and/or time the event was created or ingested, and most recently updated, and receipt information or other confirmation information of the event. Additionally or alternatively, the reporting engine 806 may generate metrics and/or analyses (hereinafter “metrics”) regarding events. For example, the metrics may include a total number of events or a total number of events of one or more specific types over a given time period across a source, a group of sources, or all sources. The metrics may further be filtered based on criteria such as statuses. In one specific example, the reporting engine 806 may generate metrics regarding numbers and/or proportions of failed operations, numbers and/or proportions of the failed operations that are successful following a reattempted operation, and/or a number of reattempts before an indication of a successful operation. In such a manner, the reportion engine 806 may provide insights regarding which sources experience a highest rate of failed operations, and/or a rate at which the failed operations are resolved. Such insights may lead to troubleshooting in an effort to reduce a rate of failed operations.

In some examples, the reporting engine 806 may generate metrics regarding source metrics, which may focus on a single source, and/or cross-source metrics, which may encompass aggregated metrics across multiple sources, such as a group of sources or all sources of a particular tenant. For example, the metrics may include an active subscriber count by source, and may include source cohort analyses, such as an evaluation of products, plans (e.g., rate plans), charges, and/or retention within a source or group of sources. For example, FIG. 9C illustrates a dashboard 922 which includes a menu 924 (e.g., a drop down menu), a search bar 925, and tabs 926. Here, in FIG. 9C, a menu “Dashboard” under “Analytics” is selected or activated, and a tab “Dashboard” is selected or activated. The dashboard 922 further includes metrics displayed in different panels. The metrics may include a revenue (e.g., a monthly recurring revenue (MRR)), active subscribers, average MRR per subscriber, net MRR changes, net billing, and/or net payments. The metrics may be displayed in a textual and/or a graphical format. In some examples, the search bar 925 may receive a query regarding one or more events, sources, event types, subscribers (e.g., consuming entities), identifiers corresponding to consuming entities, among other search terms. In some examples, upon the reporting engine 806 receiving a query corresponding to a specific consuming entity under a specific consuming entity identifier, the reporting engine 806 may identify a same consuming entity within a different source and under a different consuming entity identifier. The reporting engine 806 may include any relevant metrics of that same consuming entity under the different consuming entity identifier, and/or merge or consolidate the relevant metrics. For example, a common consuming entity K may be referred to by different identifiers, such as J and M, within sources A and B, respectively. Upon receiving a query that includes the identifier J but does not include the identifier M, the reporting engine 806 may nonetheless display information of the consuming entity K referred to under the identifier M.

Upon receiving a selection of any of the metrics, the reporting engine 806 may generate an updated or more detailed view of the selected metric. For example, in FIG. 9D, the reporting engine 806 may generate a detailed dashboard 962, which provides an alternative and/or more detailed view of the Active Subscribers panel displayed within the dashboard 922. The detailed dashboard 962 may be generated in response to receiving a selection of the “Active Subscribers” panel. The generating of the detailed dashboard 962 may also activate selection of a “Card” tab within the tabs 926. Within or associated with the dashboard 962, options 966 may include different selections of categories and metrics to be displayed, different filters which further categorize the metrics, and/or settings by which to display the metrics. Buttons or menus (hereinafter “buttons”) 964 and 966 may include or activate capabilities or functionalities (hereinafter “functionalities”) to create one or more specific groups for which metrics are displayed, and/or select one or more specific groups for which metrics are displayed or compared. For example, if the reporting engine 806 obtains information from five sources of a given tenant, including sources A, B, C, D, and E, upon receiving a selection of the button 964, the reporting engine 806 may create groups of sources, or divide the sources into groups, such as a first group including sources A, B, and C and a second group including sources D and E. The reporting engine 806, upon receiving a selection from the button 966, may receive a selection of either the first group, the second group, or both the first group and the second group for a comparison between the first group and the second group. The reporting engine 806 may output and display metrics for any one or more groups that were selected.

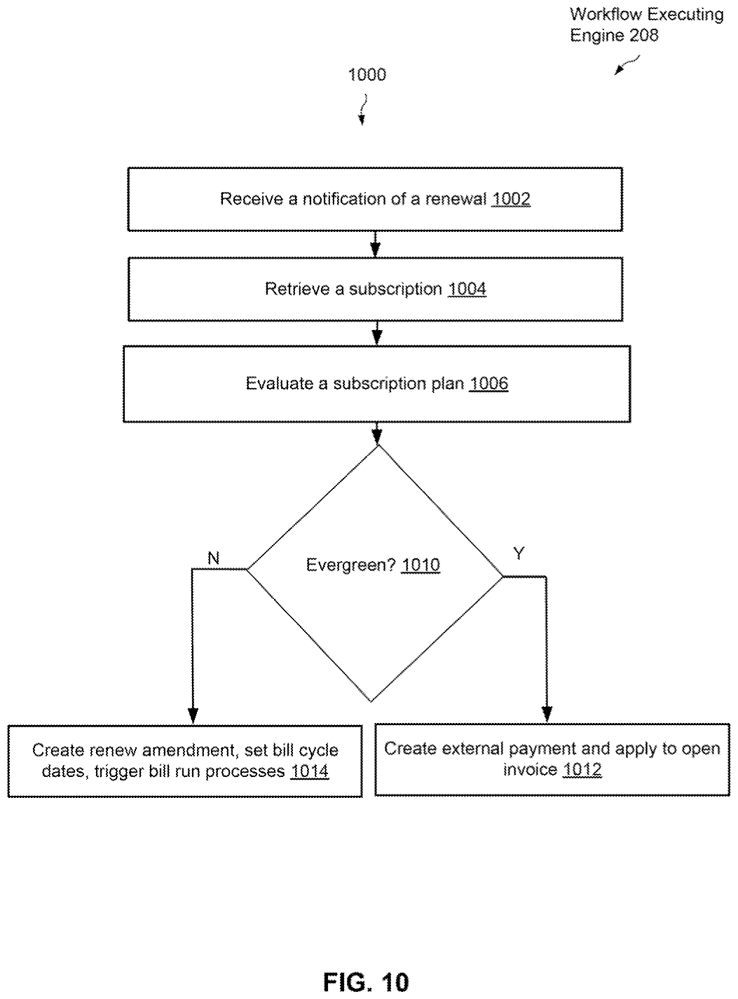

FIG. 10 is a flowchart of a method 1000 of an example workflow operation in response to a renewal event. In this and other flowcharts and/or sequence diagrams, the flowchart illustrates by way of example a sequence of steps. It should be understood the steps may be reorganized for parallel execution, or reordered, as applicable. Moreover, some steps that could have been included may have been removed to avoid providing too much information for the sake of clarity and some steps that were included could be removed, but may have been included for the sake of illustrative clarity.

The method 1000 begins with one or more hardware processors (e.g., the ingesting engine 202) receiving a notification of a renewal in step 1002. Operations of processing the notification are skipped here for the sake of brevity. In step 1004, one or more hardware processors (e.g., the workflow executing engine 208) may retrieve a subscription associated with the notification. In step 1006, the workflow executing engine 208 may evaluate a previous subscription plan associated with the renewal notification. In decision 1010, the workflow executing engine 208 may determine whether the previous subscription plan was evergreen (e.g., not requiring renewals) or termed. In step 1012, if the workflow executing engine 208 determines that the previous subscription plan is evergreen, the workflow executing engine 208 may create an external payment and apply the external payment to an open invoice. In step 1014, if the workflow executing engine 208 determines that the previous subscription plan is termed, the workflow executing engine may create a renew amendment, set bill cycle dates, and trigger billing processes.

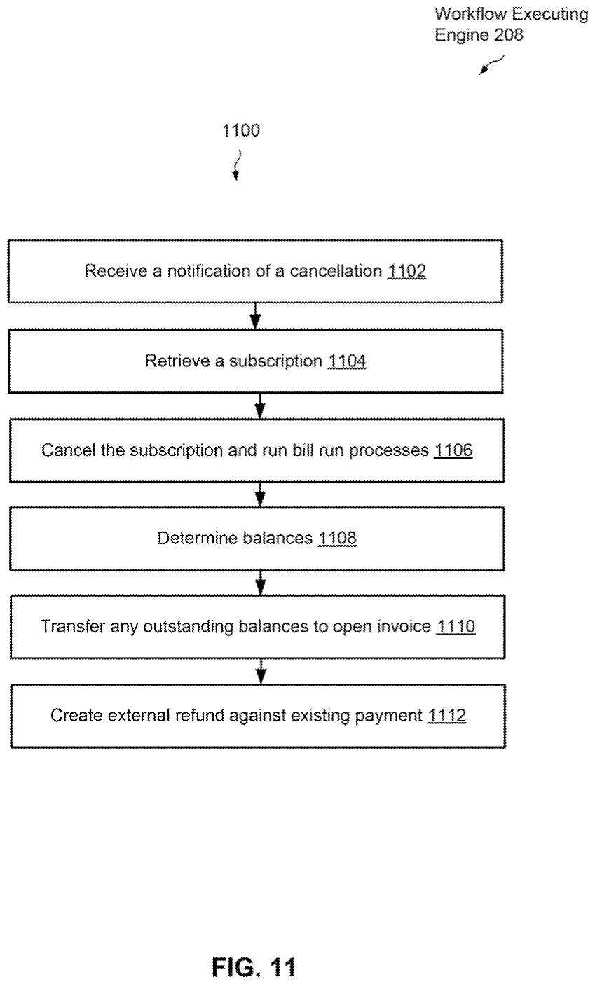

FIG. 11 is a flowchart of a method 1100 of an example workflow operation in response to a cancellation. The method 1100 begins with one or more hardware processors (e.g., the ingesting engine 202) receiving a notification of a cancellation in step 1102. Operations of processing the notification are skipped here for the sake of brevity. In step 1104, one or more hardware processors (e.g., the workflow executing engine 208) may retrieve a subscription associated with the notification. In step 1106, upon finding the subscription, the workflow executing engine 208 may cancel the subscription and run processes including billing processes. In step 1108, the workflow executing engine 208 may determine any balances that may still be owed regarding the subscription. In step 1110, the workflow executing engine 208 may transfer any outstanding balances to an open invoice. In step 1112, the workflow executing engine 208 may create an external refund against an existing payment. In some scenarios, if payments made towards the subscription exceed an owed amount, the workflow executing engine 208 may initiate a refund process.

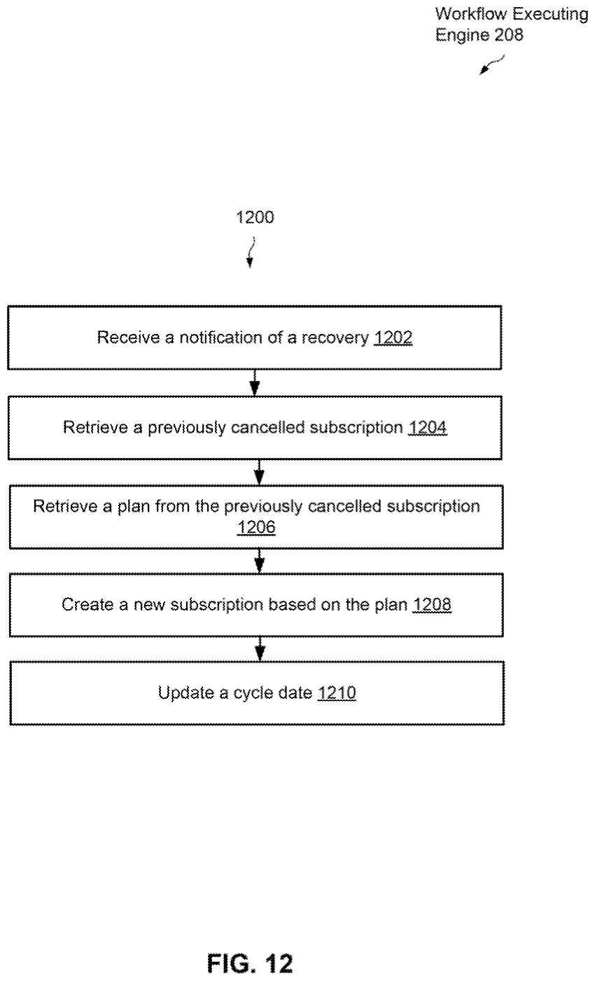

FIG. 12 is a flowchart of a method 1200 of an example workflow operation in response to a recovery, which is an attempt to reinstate a previously cancelled subscription. The method 1200 begins with one or more hardware processors (e.g., the ingesting engine 202) receiving a notification of a recovery in step 1202. Operations of processing the notification are skipped here for the sake of brevity. In step 1204, one or more hardware processors (e.g., the workflow executing engine 208) may retrieve a previously cancelled subscription associated with the notification. In step 1206, upon finding the previously cancelled subscription, the workflow executing engine 208 may retrieve a plan from that previously cancelled subscription. In step 1208, the workflow executing engine 208 may create a new subscription based on the plan. If certain policies, terms, or conditions have been modified since the previous cancellation, then the new subscription may reflect the modifications. In step 1210, the workflow executing engine 208 may update a cycle date to a time that the recovery notification was received.

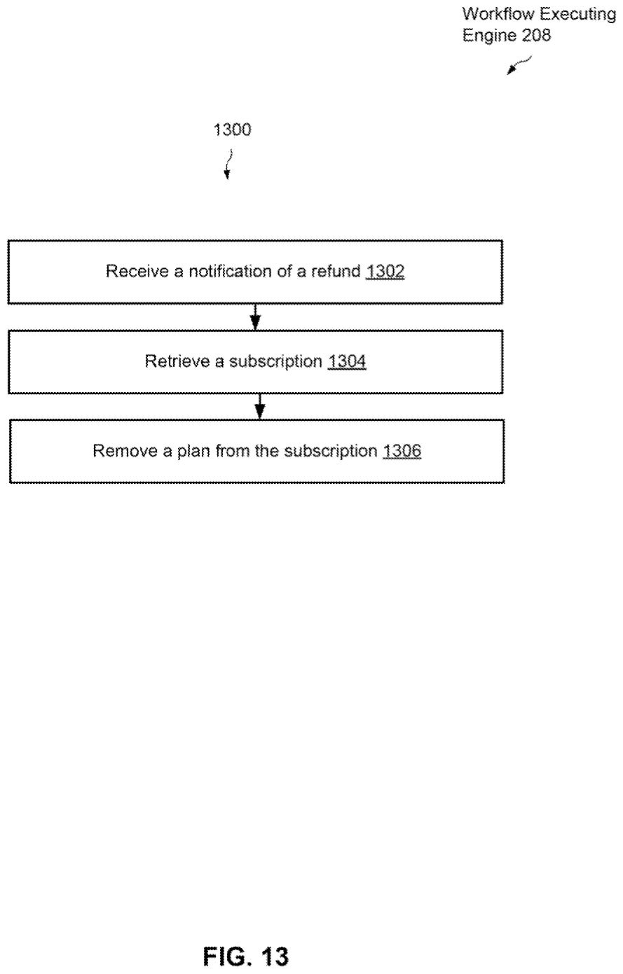

FIG. 13 is a flowchart of a method 1300 of an example workflow operation in response to a refund notification. The method 1300 begins with one or more hardware processors (e.g., the ingesting engine 202) receiving a notification of a refund in step 1302. Operations of processing the notification are skipped here for the sake of brevity. In step 1304, one or more hardware processors (e.g., the workflow executing engine 208) may retrieve a subscription associated with the notification, for example, by an identifier of the change notification that matches or correlates to an existing identifier associated with the subscription. In step 1306, upon finding the subscription, the workflow executing engine 208 may disassociate a rate plan from the subscription to prevent further charges on a cancelled subscription.

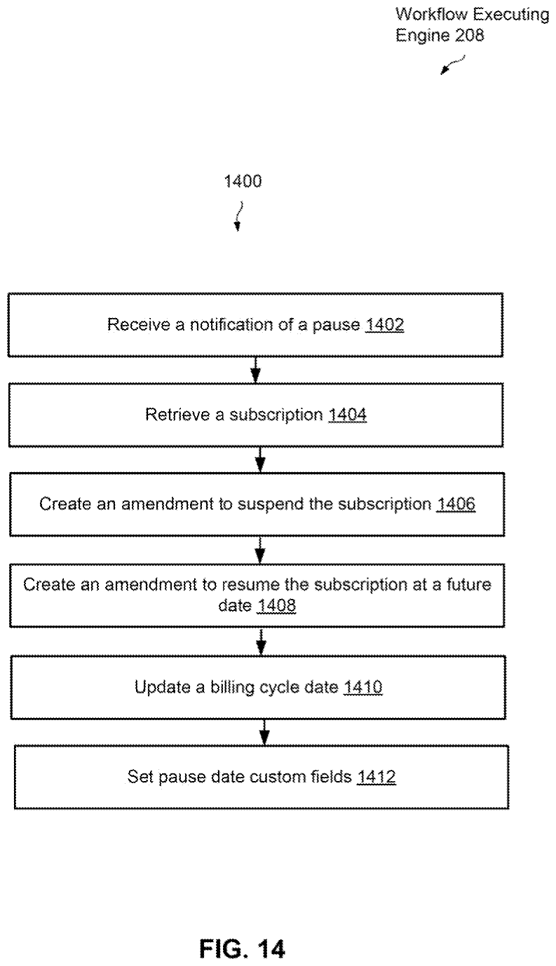

FIG. 14 is a flowchart of a method 1400 of an example workflow operation in response to a pause and/or a resume notification. The method 1400 begins with one or more hardware processors (e.g., the ingesting engine 202) receiving a notification of a pause and/or a resume notification in step 1402. Operations of processing the notification are skipped here for the sake of brevity. In step 1404, one or more hardware processors (e.g., the workflow executing engine 208) may retrieve a subscription associated with the notification. In step 1406, upon finding the subscription, the workflow executing engine 208 may create an amendment to suspend the subscription. In step 1408, the workflow executing engine 208 may create a future dated amendment to resume the subscription, if the notification includes a resume notification. In step 1410, the workflow executing engine 208 may update a billing cycle date according to the scheduled date of resumption. In step 1412, the workflow executing engine 208 may populate, to custom fields, a date range at which the subscription is suspended.

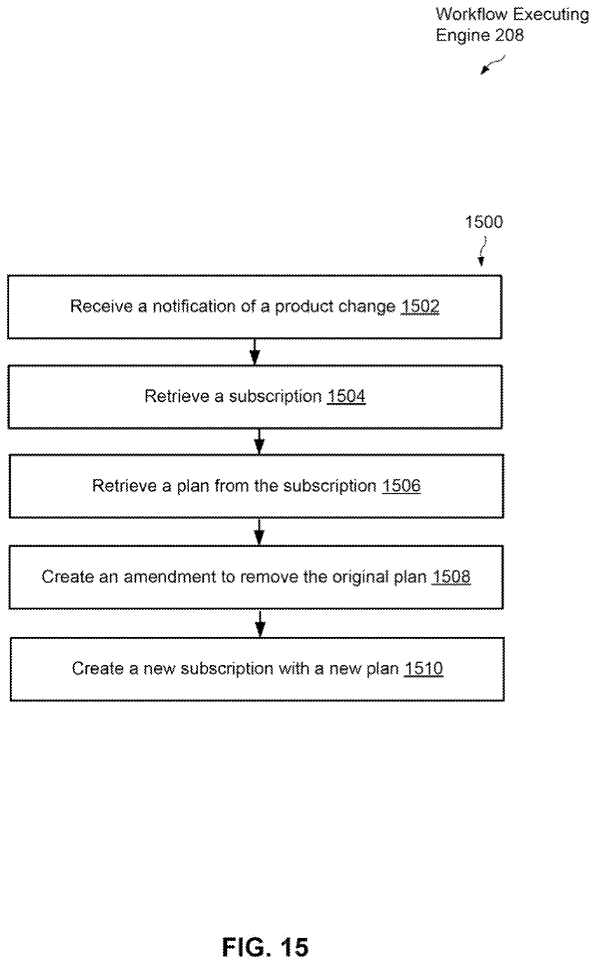

FIG. 15 is a flowchart of a method 1500 of an example workflow operation in response to a change notification. The method 1500 begins with one or more hardware processors (e.g., the ingesting engine 202) receiving a notification of a change notification in step 1502. The change may include an upgrade, a downgrade, or a crossgrade. Operations of processing the notification are skipped here for the sake of brevity. In step 1504, one or more hardware processors (e.g., the workflow executing engine 208) may retrieve a subscription associated with the notification, for example, by an identifier of the change notification that matches or correlates to an existing identifier associated with the subscription. In step 1506, upon finding the subscription, the workflow executing engine 208 may retrieve a plan from the subscription. In step 1508, the workflow executing engine 208 may create an amendment to remove the original plan. In step 1510, the workflow executing engine 208 may create a new subscription with a new plan and a new identifier for the new plan.

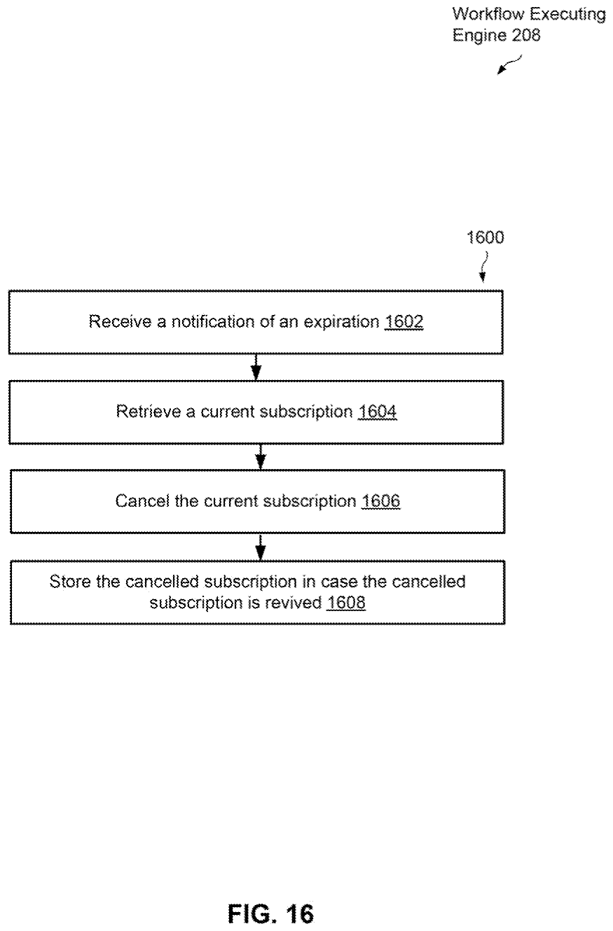

FIG. 16 is a flowchart of a method 1600 of an example workflow operation in response to an expiration notification. The method 1600 begins with one or more hardware processors (e.g., the ingesting engine 202) receiving a notification of an expiration, which may encompass a failure to renew or fulfill an obligation, in step 1602. Operations of processing the notification are skipped here for the sake of brevity. In step 1604, one or more hardware processors (e.g., the workflow executing engine 208) may retrieve a subscription associated with the notification. In step 1606, upon finding the subscription, the workflow executing engine 208 may cancel the subscription. In step 1608, the workflow executing engine 208 may store the cancelled subscription in an event that the cancelled subscription is revived, for example, via a renewal or fulfilling of an obligation.

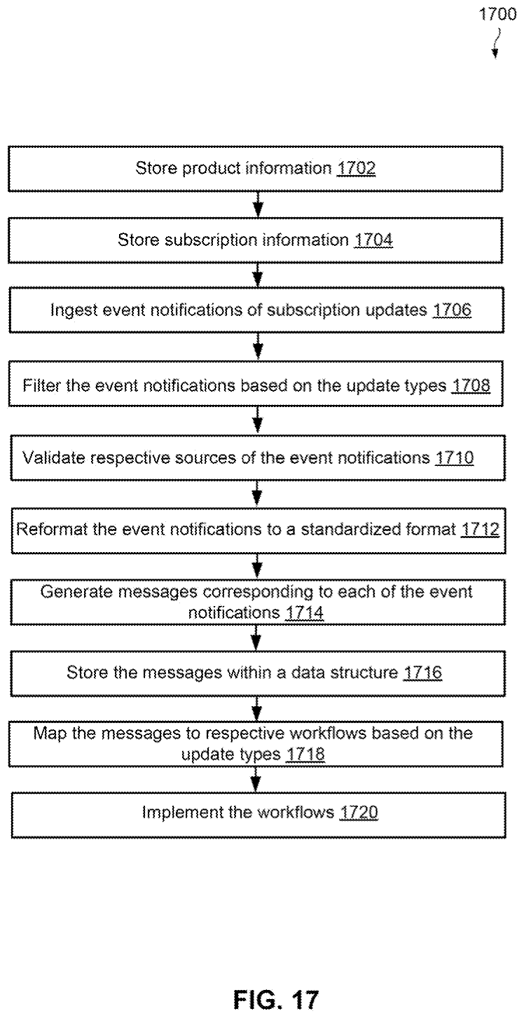

FIG. 17 is a flowchart of a method 1700 which encompasses an overall process of ingesting a notification, processing the notification, generating a message from the notification, mapping the message to a workflow operation, and implementing the workflow operation. Method 1700 begins with step 1702, in which one or more databases (e.g., as part of the datastores 114) storing product information. The product information defines subscription products (also referred to as resources) available to subscribers (also referred to as consuming entities) of a tenant (also referred to as a provisioning entity) of the multi-tenant system and sources where subscriptions to the subscription products are available.

In step 1704, one or more hardware processors (e.g., the ingesting engine 202 in FIG. 2 and/or the gateways 651, 652, and 653 in FIG. 6) may store subscription information in the one or more databases (e.g., as part of the datastores 114). The subscription information includes, for example, subscriber identifiers (e.g., identification information of any subscribers to each of the subscription products), a tenant identifier, and subscription statuses of the subscription products (e.g., whether a subscription product is available for subscription).

In step 1706, one or more hardware processors (e.g., the ingesting engine 202 in FIG. 2 and/or the gateways 651, 652, and 653 in FIG. 6) may ingest, from the sources, event notifications of subscription updates to the subscription information, the event notifications indicating update types of the subscription. For example, the event notifications may indicate an update in a subscription status of a particular subscriber to a particular subscription product, such as a subscription renewal.

In step 1708, one or more hardware processors (e.g., the ingesting engine 202 in FIG. 2 and/or the gateways 651, 652, and 653 in FIG. 6) may filter the event notifications. The filtering of the event notifications may be based on certain criteria, such as based on the update types. This filtering step may reduce unnecessary processing of certain notifications in which the events do not map to any workflow operation.

In step 1710, one or more hardware processors (e.g., the ingesting engine 202 in FIG. 2 and/or the gateways 651, 652, and 653 in FIG. 6) may validate the sources of the event notifications. The validating of the sources may be performed directly or indirectly. For example, the one or more hardware processors may directly compare a source identifier within the event notifications to a source identifier stored within the multi-tenant system 102. If the event notifications do not indicate a source identifier, then the one or more hardware processors may obtain other identifier information from the event notifications and determine a source from the other identifier information.

In step 1712, one or more hardware processors (e.g., the ingesting engine 202 in FIG. 2 and/or the gateways 651, 652, and 653 in FIG. 6) may reformat the event notifications to a standardized format.

In step 1714, one or more hardware processors (e.g., the message preparing engine 204) may generate messages corresponding to each of the reformatted, filtered and validated event notifications. The generating of messages may include, for example, appending additional fields if these fields were missing from the event notifications. These additional fields may include update type identifier (e.g., event identifier) and/or tenant identifier fields. Moreover, the generating of messages may entail requesting additional information from a source of the event notifications and appending the additional information into the messages. For example, an update type within an event notification may be indicated as a subscription change but lack an indication of whether the subscription change was an upgrade or downgrade. The message preparing engine 204 may request additional information regarding the subscription change from a source, and append this additional information to a message.

In step 1716, one or more hardware processors (e.g., the message preparing engine 204) may store the messages within a data structure, such as a queue. Next, one or more hardware processors (e.g., the message preparing engine 204) may dispatch or transmit the messages for processing according to a modified FIFO mechanism. The transmitting of the messages may be required because the processing may occur entirely or partially within a secured environment such as a walled garden.

In step 1718, one or more hardware processors (e.g., the message processing engine 206) may process the stored messages by mapping the messages to respective workflows based on the update types indicated within the messages. In step 1720, one or more hardware processors (e.g., the workflow executing engine 208) may implement the workflows mapped to the messages.

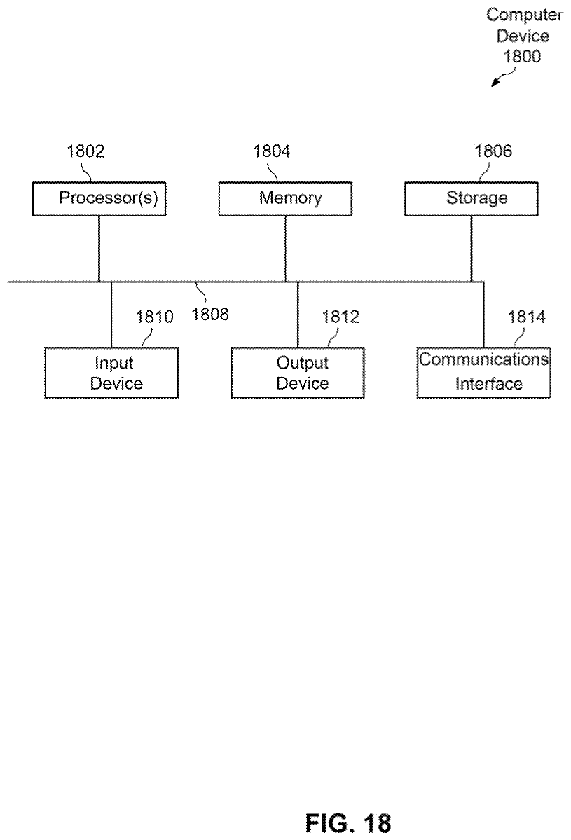

FIG. 18 is a block diagram of a computing device 1800. Any of the systems, engines, datastores, and/or networks described herein may comprise an instance of one or more computing devices 1800. In some embodiments, functionality of the computing device 1800 is improved to perform some or all of the functionality described herein. The computing device 1800 comprises a processor 1802, memory 1804, storage 1806, an input device 1810, a communication network interface 1814, and an output device 1812 communicatively coupled to a communication channel 1808. The processor 1802 is configured to execute executable instructions (e.g., programs). In some embodiments, the processor 1802 comprises circuitry or any processor capable of processing the executable instructions.

The memory 1804 stores data. Some examples of memory 1804 include storage devices, such as RAM, ROM, RAM cache, virtual memory, etc. In various embodiments, working data is stored within the memory 1804. The data within the memory 1804 may be cleared or ultimately transferred to the storage 1806.

The storage 1806 includes any storage configured to retrieve and store data. Some examples of the storage 1806 include flash drives, hard drives, optical drives, cloud storage, and/or magnetic tape. In some embodiments, storage 1806 may include RAM. Each of the memory 1804 and the storage 1806 comprises a computer-readable medium, which stores instructions or programs executable by processor 1802.

The input device 1810 may be any device that inputs data (e.g., mouse and keyboard). The output device 1812 may be any device that outputs data and/or processed data (e.g., a speaker or display). It will be appreciated that the storage 1806, input device 1810, and output device 1812 may be optional. For example, the routers/switchers may comprise the processor 1802 and memory 1804 as well as a device to receive and output data (e.g., the communication network interface 1814 and/or the output device 1812).

The communication network interface 1814 may be coupled to a network (e.g., the network system 100) via the link 1808. The communication network interface 1814 may support communication over an Ethernet connection, a serial connection, a parallel connection, and/or an ATA connection. The communication network interface 1814 may also support wireless communication (e.g., 802.11 a/b/g/n, WiMax, LTE, WiFi). It will be apparent that the communication network interface 1814 may support many wired and wireless standards.

It will be appreciated that the hardware elements of the computing device 1800 are not limited to those depicted. A computing device 1800 may comprise more or less hardware, software and/or firmware components than those depicted (e.g., drivers, operating systems, touch screens, biometric analyzers, and/or the like). Further, hardware elements may share functionality and still be within various embodiments described herein. In one example, encoding and/or decoding may be performed by the processor 1802 and/or a co-processor located on a GPU (i.e., NVidia).

It will be appreciated that an “engine,” “system,” “datastore,” and/or “database” may comprise software, hardware, firmware, and/or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, and/or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The databases/datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

The systems, methods, engines, datastores, and/or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A multi-tenant system, comprising:
one or more hardware processors; and
memory storing computer instructions, the computer instructions when executed by the one or more hardware processors configured to perform:
storing product information in one or more databases, the product information defining subscription products available to subscribers of a tenant of the multi-tenant system and sources where subscriptions to the subscription products are available;
storing subscription information in the one or more databases, the subscription information including subscriber identifiers, a tenant identifier, and subscription statuses of the subscription products;
ingesting, from the sources, event notifications of subscription updates to the subscription information, the event notifications indicating update types of the subscription updates;
filtering the event notifications based on the update types;
validating respective sources of the event notifications;
reformatting the event notifications to a standardized format;
generating messages corresponding to each of the reformatted, filtered and validated event notifications;
storing the messages within a data structure;
mapping the messages to respective workflows based on the update types; and
implementing the workflows.

2. The multi-tenant system of claim 1, wherein at least a subset of the workflows comprise transmitting a webhook to an external system.

3. The multi-tenant system of claim 1, wherein the computer instructions when executed by the one or more hardware processors are further configured to perform:
generating and transmitting, to the tenant, a synchronized view of the subscription statuses of the subscription products across the sources; and wherein:
the workflows comprise updating fields within the synchronized view corresponding to the event notifications.

4. The multi-tenant system of claim 3, wherein the computer instructions when executed by the one or more hardware processors are further configured to perform:
monitoring workflow statuses, wherein the workflow statuses indicate whether a workflow is pending, processing, completed, or has failed.

5. The multi-tenant system of claim 4, wherein the computer instructions when executed by the one or more hardware processors are further configured to perform:
in addition to storing the messages within the data structure, storing, within the one or more databases, the messages;
in response to a workflow status indicating that a first workflow corresponding to a first subscription product has failed, transmitting, to the tenant, an indication of the failed first workflow;
receiving, from the tenant, an indication of an update to the product information;
updating the product information according to the indication;
implementing the first workflow according to the first message and the updated product information.

6. The multi-tenant system of claim 1, wherein the filtering comprises filtering out any event notifications in which the corresponding update types are unmapped to any workflows.

7. The multi-tenant system of claim 1, wherein:
the event notifications comprise first event notifications from a first source and second event notifications from a second source; and
the first event notifications comprise a first format and the second event notifications comprise a second format; and
the reformatting comprises converting, into the standardized format, the first event notifications and the second event notifications.

8. The multi-tenant system of claim 7, wherein:
the ingesting of the event notifications comprises ingesting the first event notifications into a first gateway and ingesting the second event notifications into a second gateway.

9. The multi-tenant system of claim 1, wherein the data structure comprises a queue.

10. The multi-tenant system of claim 1, wherein the event notifications comprise changes in the subscription statuses; and the messages indicate the tenant identifier and the update types.

11. A method implemented by a multi-tenant system, the method comprising:
storing product information in one or more databases, the product information defining subscription products available to subscribers of a tenant of the multi-tenant system and sources where subscriptions to the subscription products are available;
storing subscription information in the one or more databases, the subscription information including subscriber identifiers, a tenant identifier, and subscription statuses of the subscription products;
ingesting, from the sources, event notifications of subscription updates to the subscription information, the event notifications indicating update types of the subscription updates;
filtering the event notifications based on the update types;
validating respective sources of the event notifications;
reformatting the event notifications to a standardized format;
generating messages corresponding to each of the reformatted, filtered and validated event notifications;
storing the messages within a data structure;
mapping the messages to respective workflows based on the update types; and
implementing the workflows.

12. The method of claim 11, wherein at least a subset of the workflows comprise transmitting a webhook to an external system.

13. The method of claim 11, further comprising:
generating and transmitting, to the tenant, a synchronized view of the subscription statuses of the subscription products across the sources; and wherein:
the workflows comprise updating fields within the synchronized view corresponding to the event notifications.

14. The method of claim 13, further comprising:
monitoring workflow statuses, wherein the workflow statuses indicate whether a workflow is pending, processing, completed, or has failed.

15. The method of claim 14, further comprising:
in addition to storing the messages within the data structure, storing, within the one or more databases, the messages;
in response to a workflow status indicating that a first workflow corresponding to a first subscription product has failed, transmitting, to the tenant, an indication of the failed first workflow;
receiving, from the tenant, an indication of an update to the product information;
updating the product information according to the indication;
implementing the first workflow according to the first message and the updated product information.

16. The method of claim 11, wherein the filtering comprises filtering out any event notifications in which the corresponding update types are unmapped to any workflows.

17. The method of claim 11, wherein:
the event notifications comprise first event notifications from a first source and second event notifications from a second source; and
the first event notifications comprise a first format and the second event notifications comprise a second format; and
the reformatting comprises converting, into the standardized format, the first event notifications and the second event notifications.

18. The method of claim 17, wherein:
the ingesting of the event notifications comprises ingesting the first event notifications into a first gateway and ingesting the second event notifications into a second gateway.

19. The method of claim 11, wherein the data structure comprises a queue.

20. The method of claim 11, wherein the event notifications comprise changes in the subscription statuses; and the messages indicate the tenant identifier and the update types.
